(19) United States
(12) Patent Application Publication
(10) Pub. No.: US 2009/0160754 A1
(43) Pub. Date: Jun. 25, 2009

(54) LIQUID CRYSTAL DISPLAY DEVICE, TELEVISION APPARATUS, AND METHOD FOR CONTROLLING LIQUID CRYSTAL DISPLAY DEVICE

(75) Inventor: Kenichi Nagai, Isesaki-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/198,795

(22) Filed: Aug. 26, 2008

(30) Foreign Application Priority Data
Dec. 25, 2007 (JP) 2007-332598

(51) Int. Cl. G09G 3/36

(52) U.S. Cl. 345/102

(57) ABSTRACT

A liquid crystal display device is provided with a color LCD panel having a plurality of pixels, an LCD driver for driving the respective pixels of the LCD panel based on R, G, and B signals, a backlight for illuminating the LCD panel, a light control section for controlling a brightness of the illumination by the backlight, and a gain control section for controlling gains of the R, G, and B signals by each color in accordance with the brightness of the illumination controlled by the light control section.

### CROSS-REFERENCE TO RELATED APPLICATION

This application is based upon and claims the benefit of priority from the prior Japanese Patent Application No. 2007-332598, filed on Dec. 25, 2007; the entire contents of which are incorporated herein by reference.

### BACKGROUND

1. Field of the Invention

The present invention relates to a liquid crystal display device, a television apparatus provided therewith, and a method for controlling the liquid crystal display device.

2. Description of the Related Art

A field sequential color liquid crystal display device performs a color display by combining an LED being a backlight for sequentially emitting lights of R, G, and B, and a liquid crystal panel capable of being rewritten at high speed (refer to, for example, JP-A 2003-44016 (KOKAI)).

Here, in order to enhance a power efficiency, the liquid crystal display device disclosed in the aforementioned Patent Document differs a light emission period of respective light sources of R, G, and B, according to a superiority or inferiority of light emission efficiency of the respective light sources. Meanwhile, in order not to lose a white balance due to the aforementioned control of the light emission period of the respective light sources, the liquid crystal display device disclosed in the above-described Patent Document has a function for controlling luminances of the respective light sources at the time of light emission.

### SUMMARY

However, a liquid crystal display device specified to apply a fluorescent lamp emitting a monochromatic (white) light as a backlight, and to conduct a light control by controlling a time interval between ON and OFF of the fluorescent lamp by varying a duty ratio of pulse shape, has a problem as follows.

Specifically, the liquid crystal display device specified as above has a problem such that, due to the difference in persistence characteristics of respective R, G, and B phosphors coated on the fluorescent lamp, when the brightness is changed by the light control, a chromaticity (white balance) of the backlight is also changed simultaneously.

Accordingly, the present invention has been made to solve the above-described problems, and an object thereof is to provide a liquid crystal display device, a television apparatus, and a method for controlling the liquid crystal display device which are capable of suppressing a change in chromaticity which may be occurred due to the difference in brightness of illumination with respect to a liquid crystal panel.

A liquid crystal display device according to one aspect of the present invention includes: a liquid crystal panel having a plurality of pixels; a driving section driving the respective pixels of the liquid crystal panel based on R, G, and B signals; an illumination section illuminating the liquid crystal panel; alight control section controlling a brightness of the illumination by the illumination section; and a gain control section controlling gains of the R, G, and B signals by each color in accordance with the brightness of the illumination controlled by the light control section.

Further, a television apparatus according to one aspect of the present invention is structured by mounting therein the aforementioned liquid crystal display device according to the one aspect of the present invention.

Furthermore, a method for controlling a liquid crystal display device according to one aspect of the present invention includes: a step of controlling a setting of a brightness for illuminating a liquid crystal panel; a step of controlling gains of R, G, and B signals by each color in accordance with the controlled setting of the brightness; a step of illuminating the liquid crystal panel based on the controlled setting of the brightness; and a step of driving respective pixels of the liquid crystal panel based on the R, G, and B signals with controlled gains.

### BRIEF DESCRIPTION OF THE DRAWINGS

FIG. 1 is a block diagram functionally showing a structure of a liquid crystal display device according to the first embodiment of the present invention.

FIG. 2 is a view for explaining a method for controlling a brightness of a backlight built in the liquid crystal display device shown in FIG. 1.

FIG. 3 is a view showing persistence characteristics of phosphors coated on the backlight built in the liquid crystal display device of FIG. 1.

FIG. 4 is a view showing a correspondence between a brightness and a luminescent color of the backlight provided to the liquid crystal display device of FIG. 1.

FIG. 5 is a view showing a correspondence between the brightness of the backlight provided to the liquid crystal display device of FIG. 1 and gains of R, G, and B signals to be controlled.

FIG. 6 is a flow chart showing a processing when performing a light control of the backlight provided to the liquid crystal display device shown in FIG. 1.

FIG. 7 is a block diagram functionally showing a structure of a television apparatus according to the second embodiment of the present invention which is mounted therein the liquid crystal display device shown in FIG. 1.

### DETAILED DESCRIPTION

Hereinafter, embodiments of the present invention will be described in detail based on the drawings.

### First Embodiment

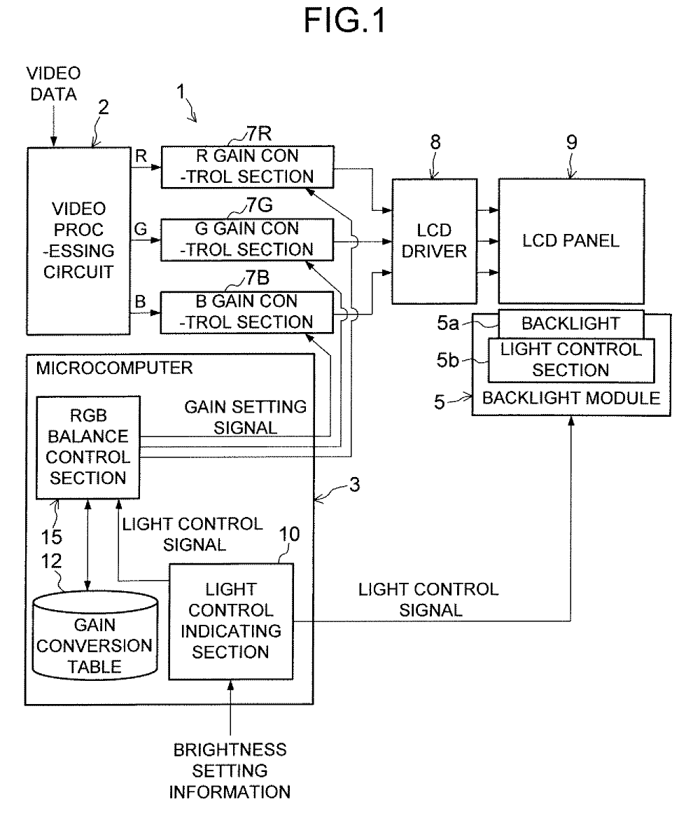

As shown in FIG. 1, a liquid crystal display device 1 of the present embodiment is mainly provided with a video processing circuit 2, gain control sections 7R, 7G, and 7B, an LCD driver 8, an LCD panel 9, a backlight module 5, and a microcomputer 3. The video processing circuit 2 inputs video data of a predetermined format from the outside, and outputs R, C, and B signals having luminance information by each color (by each light of three primary colors of red, blue, and green) as video signals.

The gain control sections 7R, 7G, and 7B may be provided as a single gain control section which has all the functions of the gain control sections 7R, 7G, and 7B respectively.

The gain control sections 7R, 7G, and 7B amplify the R, G, and B signals input from a side of the video processing circuit 2, based on the gain being set by the microcomputer 3 (RGB balance control section 15 in the microcomputer 3) by each color, and output to a side of the LCD driver 8.

The LCD driver 8 is formed of a source driver and a gate driver, and drives the LCD panel 9 (each pixel of the LCD panel 9) based on the R, G, and B signals input from sides of the gain control sections 7R, 7G, and 7B.

The LCD panel 9 is a transmission-type color liquid crystal panel having a plurality of pixels. For example, the LCD panel 9 is formed by sealing a liquid crystal between glass plates on which polarizing plates are disposed, via transparent electrodes and alignment layers. An orientation in which the liquid crystal is arranged, i.e. deviation angle, is controlled by a voltage applied to the transparent electrodes disposed in a matrix shape.

Note that the matrix-shaped transparent electrodes are disposed so as to correspond to a plurality of pixel regions of the LCD panel 9. The deviation angle of the liquid crystal is controlled by controlling the voltage applied to the transparent electrodes in the LCD panel 9.

The backlight module 5 is provided with a backlight 5a, a light control section 5b, a power supply section for supplying an electric power for lighting the backlight 5a via the light control section 5b, and the like. To the backlight 5a as an illumination section for illuminating the LCD panel 9, a cold cathode fluorescent lamp (CCFL) being a fluorescent lamp with long product life and small current consumption is applied.

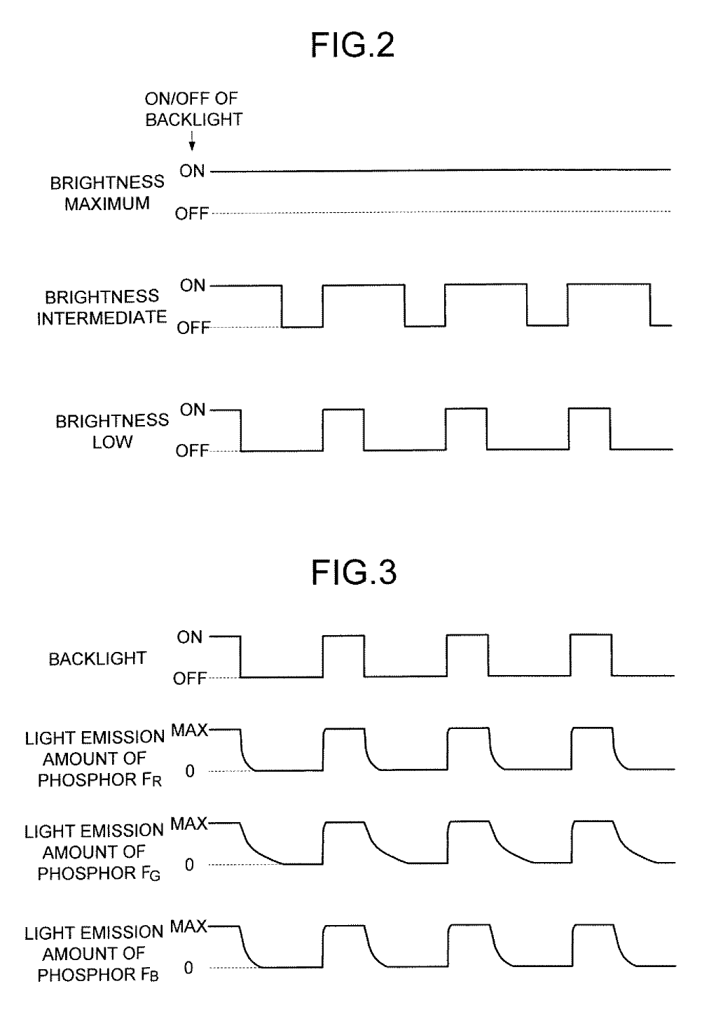

The light control section 5b is for controlling a brightness of the illumination by the backlight 5a. As shown in FIG. 2, the light control section 5b periodically turns on (ON) and turns off (OFF) the backlight 5a (illumination by the backlight 5a) and controls a ratio between the ON-period and the OFF-period of the backlight 5a, i.e. varies a duty ratio of pulse shape, to perform a light control.

In other words, as shown in FIG. 2, by continuously lighting the backlight 5a, the light control section 5b controls the brightness of the backlight 5a at a maximum level (brightness: maximum). Further, the light control section 5b controls the brightness of the backlight 5a at an intermediate level (brightness: intermediate), and at a low level (brightness:low) by setting the duty ratio of the pulse shape to a relatively large value, and by setting the duty ratio to a relatively small value, respectively.

The microcomputer 3 is provided with a light control indicating section 10, a gain conversion table 12, and an RGB balance control section 15. The light control indicating section 10 inputs brightness setting information and accepts input of the brightness setting information, obtained when for example, a user performs an external input operation, an external device shifts to a low power consumption mode, or the like.

The light control indicating section 10 outputs a light control signal for making the light control section 5b perform the light control of the backlight 5a, to the light control section 5b, based on the accepted input of brightness setting information. Further, at the same time, the light control indicating section 10 outputs a light control signal having a brightness setting information of the backlight 5a, to the RGB balance control section 15.

The gain conversion table 12 stores the brightness setting information (brightness set values) of the backlight 5a and gain set values with which the gain control sections 7R, 7G, and 7B control the gains of the R, G, and B signals by each color, in a corresponding one-on-one manner. When receiving the light control signal from the light control indicating section 10, the RGB balance control section 15 refers to the gain conversion table 12, and determines the gain set values corresponding to the brightness set values possessed by the received light control signal by each color of the R, G, and B signals by calculation.

Further, the RGB balance control section 15 outputs the three kinds of gain set values determined (calculated) by each color of the R, G, and B signals, to the sides of the gain control sections 7R, 7G, and 7B, respectively, as gain control signals (referred as “gain setting signals” in FIG. 1). Specifically, the gain control sections 7R, 7G, and 7B mainly cooperate with the aforementioned RGB balance control section 15, and controls the gains of the R, G, and B signals by each color according to the brightness of the backlight 5a as illumination controlled by the light control section 5b.

Here, the liquid crystal display device 1 of the present embodiment is specified to apply the fluorescent lamp (cold cathode fluorescent lamp) as the backlight 5a, and further to perform the light control by controlling the ratio between the periodical ON-period and the OFF-period of the fluorescent lamp. Therefore, there is a concern that the liquid crystal display device 1 of the present embodiment may have a problem that, as shown in FIG. 3, due to the difference in persistence characteristics of respective red light emitting phosphor F_{R}, green light emitting phosphor F_{G}, and blue light emitting phosphor F_{B} coated on the backlight 5a, a chromaticity of the backlight, i.e. white balance thereof, is forced to be changed in accordance with the change of the brightness of the illumination.

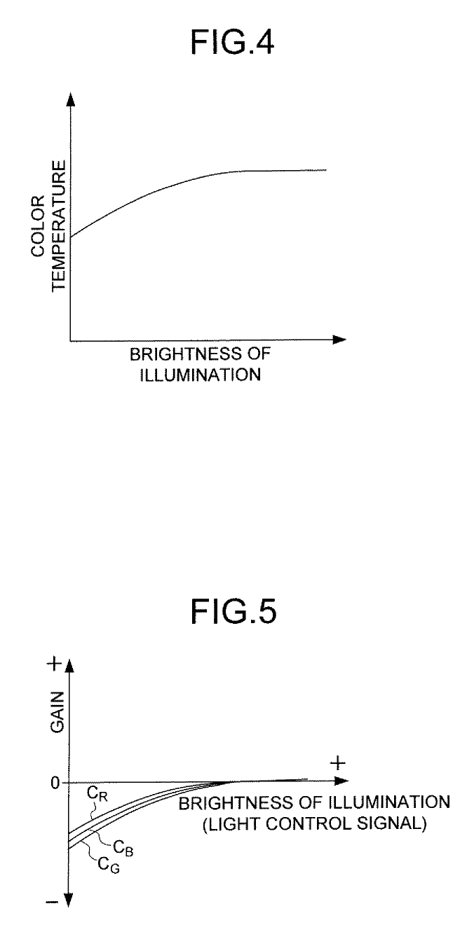

If explained in detail, in an example in FIG. 3, an afterglow of the green light emitting phosphor F_{G} tends to be remained, so that the green color is emphasized in the luminescent color of the backlight 5a. Further, such a tendency in which the afterglow of the phosphor F_{G} is remained is appeared more significantly when the brightness is set to be dark, as confirmed in FIG. 4, which may largely change a color temperature of the luminescent color of the backlight 5a.

Accordingly, the liquid crystal display device 1 of the present embodiment controls the gains of the R, G, and B signals by each color which drive each pixel of the LCD panel 9, by means of the aforementioned gain conversion table 12, RGB balance control section 15, and gain control sections 7R, 7G, and 7B, so that the chromaticity and color temperature do not change very much even when the brightness is set to be dark. By controlling the gains of the R, G, and B signals by each color, it becomes possible that the liquid crystal display device 1 of the present embodiment corrects the change in chromaticity when the light of illumination transmits the liquid crystal panel.

Specifically, as shown in FIG. 5, the aforementioned gain conversion table 12 stores the brightness set values of the backlight 5a and the gain set values (C_{R}, C_{G}, and C_{B}, being respective gain control value of R, G, and B) for controlling the gains of the R, G, and B signals by each color through the gain control sections 7R, 7G, and 7B, by corresponding them to each other in a one-on-one manner.

Concretely, regarding the green color, for example, whose afterglow tends to be remained as confirmed in FIG. 3, the gain control section 7G lowers the gain thereof relatively largely, as shown in FIG. 5. Meanwhile, regarding the red color whose afterglow is relatively hard to be remained, the gain thereof is lowered, but not largely, by the gain control section 7R. As above, the gain control sections 7R, 7G, and 7B correct the white balance by changing the gain control ratio by each color.

Note that such gain control values C_{R}, C_{G}, and C_{B} are previously prepared by, for example, determining the persistence characteristics of the respective colors (three primary colors) by each type unit of the backlight 5a by a measurement, and the like, and are stored in a storage section of the microcomputer 3 as the gain conversion table 12, at the time of manufacturing the liquid crystal display device 1.

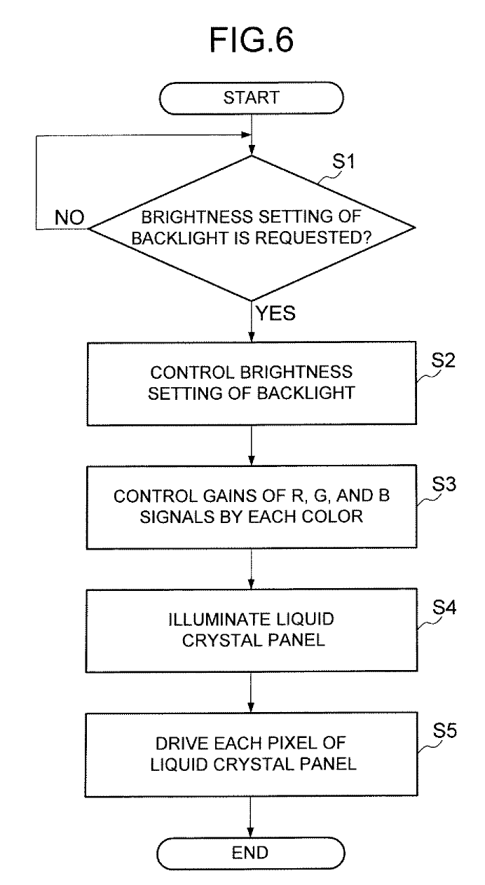

Next, a processing when performing the light control of the backlight 5a using thus structured liquid crystal display device 1 will be explained based on a flow chart shown in FIG. 6.

As shown in FIG. 6, when a brightness setting requirement of the backlight 5a is generated through, for example, the external input operation from the user, or the like (S1), the light control indicating section 10 inputs the brightness setting information and accepts input of the brightness setting information based on the brightness setting requirement. The light control indicating section 10 outputs the light control signal based on the accepted input brightness setting information to the light control section 5b, to thereby set the brightness of the backlight 5a (S2).

At this time, the light control indicating section 10 also outputs the light control signal to the RGB balance control section 15. The RGB balance control section 15 receiving the light control signal determines the gain set values (gain control values C_{R}, C_{G}, and C_{B} shown in FIG. 5) corresponding to the brightness set values possessed by the light control signal while referring to the gain conversion table 12 by calculation. The RGB balance control section 15 outputs the determined three kinds of gain set values to the sides of the gain control sections 7R, 7G, and 7B, respectively, as the gain control signals.

The gain control sections 7R, 7G, and 7B receiving the gain control signals control the gains of the R, G, and B signals by each color (S3). Accordingly, the backlight 5a illuminates the LCD panel 9 based on the controlled setting of the brightness (S4). Further, at this time, the LCD driver 8 drives each pixel of the LCD panel 9 based on the R, G, and B signals whose gains are controlled by each color, and displays a video (S5).

As described above, the gains of the R, G, and B signals are controlled by the liquid crystal display device 1 according to the present embodiment so as to correspond to the difference in persistence characteristics of the respective red light emitting phosphor F_{R}, green light emitting phosphor F_{G}, and blue light emitting phosphor F_{B} coated on the backlight 5a. Accordingly, when the light of the backlight 5a transmits the LCD panel 9, the chromaticity thereof (white balance of the illumination) is corrected.

### Second Embodiment

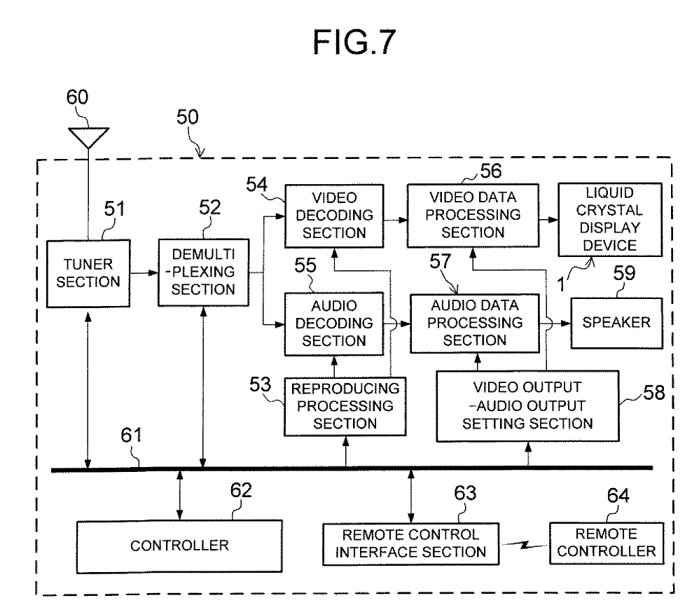

Next, the second embodiment of the present invention will be explained based on FIG. 7. Here, FIG. 7 is a block diagram functionally showing a structure of a television apparatus (digital television apparatus) according to the present embodiment.

A television apparatus 50 is a liquid crystal television apparatus. As shown in FIG. 7, this television apparatus 50 is provided with the liquid crystal display device 1 described in the aforementioned the first embodiment, a tuner section 51, a demultiplexing section 52, a reproducing processing section 53, a bus 61, a video decoding section 54, an audio decoding section 55, an audio data processing section 57 such as, for example, a stereo speaker 59, a video data processing section 56, a video output, audio output setting section 58, a remote controller 64, a remote control interface section 63, and a controller 62 for generally controlling the respective sections.

The remote control interface section 63 is an interface section with the remote controller 64 having a power button and a channel switching button with which the user performs the input operation. The tuner section 51 selects a desired broadcast wave (broadcast station) from broadcast waves of, for example, terrestrial digital broadcast or the like, received via an antenna 60.

The demultiplexing section 52 respectively demultiplexes an audio signal and a video signal being demultiplexed in the broadcast wave, and outputs to the audio decoding section 55 and the video decoding section 54, respectively. The reproducing processing section 53 controls the audio decoding section 55 and the video decoding section 54, and decodes the signals demultiplexed in the demultiplexing section 52.

Concretely, the audio decoding section 55 decodes the audio signal demultiplexed in the demultiplexing section 52, and outputs the decoded digital audio signal to the audio data processing section 57. The video decoding section 54 decodes the video signal demultiplexed in the demultiplexing section 52, and outputs the decoded digital video signal to the video data processing section 56.

The audio data processing section 57 and the video data processing section 56 perform predetermined audio processing and image processing with respect to the decoded digital audio signal and digital video signal. To later stages of the audio data processing section 57 and the video data processing section 56, the speaker 59 and the liquid crystal display device 1 are respectively connected.

The video output audio output setting section 58 can perform a setting regarding the video output such as a brightness and a contrast which can be controlled by the video data processing section 56, and a setting regarding the audio output such as a balance and a low/high tone which can be controlled by the audio data processing section 57.

Here, for instance, when the setting of the brightness of the liquid crystal display device 1 is performed by the user through the remote controller 64, via the remote control interface section 63, the video output-audio output setting section 58, and the video data processing section 56, the light control indicating section 10 in the microcomputer 3 shown in FIG. 1 inputs the brightness setting information. Based on this, similarly as the aforementioned the first embodiment, the gain control sections 7R, 7G, and 7B control the gains of the R, G, and B signals by each color. Accordingly, the white balance of the luminescent color of the backlight 5a is corrected.

As described hereinabove, the present invention has been concretely described on the basis of the aforementioned embodiments, but, the present invention is not limited to these embodiments and various modifications can be made without departing from the scope of the invention. For example, the aforementioned the second embodiment shows an example where the liquid crystal display device 1 shown in FIG. 1 is mounted in the television apparatus. However, an embodiment of the present invention is not limited to this, and it can be such that the liquid crystal display device 1 shown in FIG. 1 is mounted in electronic devices such as a mobile phone and a PC.

What is claimed is:

1. A liquid crystal display device, comprising:
a liquid crystal panel having a plurality of pixels;
a driving section driving the respective pixels of the liquid crystal panel based on R, G, and B signals;
an illumination section illuminating the liquid crystal panel;
a light control section controlling a brightness of the illumination by the illumination section; and
a gain control section controlling gains of the R, G, and B signals by each color in accordance with the brightness of the illumination controlled by the light control section.

2. The liquid crystal display device according to claim 1,
wherein the light control section periodically turns on and off the illumination by the illumination section and controls a ratio between the ON-period and the OFF-period of the illumination, to perform a light control.

3. The liquid crystal display device according to claim 1,
wherein the illumination section is provided with a fluorescent lamp as a light source.

4. The liquid crystal display device according to claim 1,
wherein the illumination section is provided with a fluorescent lamp as a light source, and
wherein the fluorescent lamp is coated with a red light emitting phosphor, a green light emitting phosphor, and a blue light emitting phosphor thereon, each of the red light emitting phosphor, the green light emitting phosphor, and the blue light emitting phosphor having a different persistence characteristic.

5. The liquid crystal display device according to claim 1,
wherein the illumination section is provided with a cold cathode fluorescent lamp being one kind of a fluorescent lamp as a light source.

6. The liquid crystal display device according to claim 1,
wherein the illumination section is provided with a cold cathode fluorescent lamp being one kind of a fluorescent lamp as a light source, and
wherein the cold cathode fluorescent lamp is coated with a red light emitting phosphor, a green light emitting phosphor, and a blue light emitting phosphor thereon, each of the red light emitting phosphor, the green light emitting phosphor, and the blue light emitting phosphor having a different persistence characteristic.

7. A television apparatus having a liquid crystal display device, comprising:
a liquid crystal panel having a plurality of pixels;
a driving section driving the respective pixels of the liquid crystal panel based on R, G, and B signals;
an illumination section illuminating the liquid crystal panel;
a light control section controlling a brightness of the illumination by the illumination section; and
a gain control sections controlling gains of the R, G, and B signals by each color in accordance with the brightness of the illumination controlled by the light control section.

8. A method for controlling a liquid crystal display device, comprising:
controlling a setting of a brightness for illuminating a liquid crystal panel;
controlling gains of R, G, and B signals by each color in accordance with the controlled setting of the brightness;
illuminating the liquid crystal panel based on the controlled setting of the brightness; and
driving respective pixels of the liquid crystal panel based on the R, G, and B signals with controlled gains.
